(19) United States
(12) Patent Application Publication
(10) Pub. No.: US 2013/0306560 A1
(43) Pub. Date: Nov. 21, 2013

(54) PVDF MEMBRANES HAVING A SUPERHYDROPHOBIC SURFACE

(71) Applicants: Andre Deratani, Castelnau Le Lez (FR); Damien Quemener, Montpellier (FR); Denis Booyer, Castries (FR); Celine Pochat-Bohatier, Clapiers (FR); Chia-Ling Li, Hsinchu (TW); Juin-Yih Lai, Zhongli City (TW); Da-Ming Wang, Taipei City (TW)

(72) Inventors: Andre Deratani, Castelnau Le Lez (FR); Damien Quemener, Montpellier (FR); Denis Booyer, Castries (FR); Celine Pochat-Bohatier, Clapiers (FR); Chia-Ling Li, Hsinchu (TW); Juin-Yih Lai, Zhongli City (TW); Da-Ming Wang, Taipei City (TW)

(21) Appl. No.: 13/988,517

(22) PCT Filed: Nov. 22, 2011
(86) PCT No.: PCT/FR2011/052730

§ 371 Date: Jul. 9, 2013

(30) Foreign Application Priority Data
Nov. 22, 2010 (FR) 1059604

(51) Int. Cl. B01D 71/34; B01D 67/00; H01M 2/16; B01D 61/00

(52) U.S. Cl. CPC B01D 71/34; B01D 61/00; B01D 67/0002; H01M 2/1653
USPC 210/650; 210/500.42; 429/254; 526/255; 427/243

(57) ABSTRACT

The present invention relates to the field of hydrophobic solid surfaces, and more particularly to polyvinylidene fluoride (PIMP) membranes having a superhydrophobic surface. The invention also relates to the process for preparing these membranes and also to the industrial applications thereof. The PVDF membranes according to the invention comprise a superhydrophobic surface comprising a structure that is porous on the nanometer scale and interconnected crystalline nodules of micrometer size.”

The present invention relates generally to the field of hydrophobic solid surfaces, and more particularly to polyvinylidene fluoride (PVDF) membranes having a superhydrophobic surface. The invention also relates to the process for preparing these membranes and also to the industrial applications thereof.

The term “superhydrophobic” is understood to mean the feature of a surface on which a drop of water forms with said surface a contact angle of greater than or equal to 150°. Superhydrophobicity is a known physical property which corresponds to Cassie's law. By definition, the contact angle is a dihedral angle formed by two contiguous interfaces at their apparent intersection. In this case, the surface is described as “non-wetting” with respect to water. This property is commonly referred to as the “lotus effect”. Superhydrophobic surfaces have a significant roughness. Indeed, it is the nanometric roughness of a surface which imparts the property of superhydrophobicity, as shown in the publication by Lafuma A. and Quéré D. (2003): “Superhydrophobic States”, Nature Materials, 2 (457-460).

Polymer membranes are generally produced by a phase inversion process. The introduction of a non-solvent into a polymer solution causes a separation between a polymer-rich phase, constituting the continuous matrix of the material, and a polymer-poor discontinuous phase that is the origin of the pores.

It is known to manufacture highly hydrophobic surfaces using various methods such as sol-gel techniques, plasma treatments, casting processes, phase inversion processes that are vapor-induced or induced by precipitation from solutions.

In the vapor-induced phase inversion (VIPS) process, a step of evaporation in a moist atmosphere precedes the immersion in the coagulation bath. In this method, the moist air plays a crucial role in the formation of a highly hydrophobic hierarchical structure. This type of structure makes it possible to trap the air and prevents dose contact of the water with the surface.

Such structures were obtained by N. Zhao et al., Macromol. Rapid Commun., 2005, 26, 1075-1080, using the aforementioned VIPS process. These authors demonstrate that it is possible to form films of polycarbonate, a semicrystalline polymer, having a superhydrophobic surface by drying in a moist atmosphere. The morphology obtained shows the formation of nodules with a flower-like structure at the surface.

This technology does not however make it possible to manufacture mechanically stable superhydrophobic PVDF membranes.

Highly hydrophobic PVDF membranes have already been described.

T. H. Young et al., Polymer: 40 (1999) 5315-5333 obtained the following two morphologies from solutions of PVDF:
by precipitation from a PVDF/DMF solution in water, the rapid introduction of the non-solvent means that the mixture very rapidly ends up in the domain of liquid-liquid demixing; in this case, the morphology is that of a conventional asymmetric membrane made from a dense surface skin supported on a spongy structure with more or less macrovoids;
by precipitation from a PVDF/DMF solution in octanol, the slow introduction of the non-solvent means that the mixture remains in the zone of solid-liquid demixing (crystallization domain) for a long enough time, which gives a morphology of dense, non-interconnected nodules.

Mao Peng et al., J. Appl. Polym. Sci.: 98 (2005) 1358-1363 prepared PVDF membranes from a solution containing 20% by weight of PVDF in DMAc using three processes:
a first process by precipitation in a coagulation bath consisting of water (conventional phase separation already described in the work by T. H. Young with DMF as the solvent), which gives asymmetric membranes with a smooth filtering surface layer having a water contact angle of 85.2°±3.2°;
a second process by addition of DMAc to the coagulation bath, which gives symmetric membranes, the surface of which has a water contact angle of around 140°±5° when the proportion of DMAc is between 65% and 75% (see the data from Table 1 of this document). The membranes obtained by this process are highly swollen, not very mechanically stable and their surface is not homogeneous (as indicated on page 1362, right-hand column, 1^{st} paragraph). Furthermore, this process has the drawback of consuming a lot of solvent;
a third process by precipitation by VIPS in moist air, which gives symmetric membranes consisting of crystalline nodules of 4 microns resulting from the agglomeration of dense spheres of a few hundreds of nm in size and the surface of which has a water contact angle generally of between 144° and 149° with an example at 150.6°±0.4°.

C. Y. Kuo et al., Desalination: 233 (2008) 40-47, studied the precipitation of a solution of PVDF/NMP in light alcohols such as methanol, ethanol, n-propanol and n-butanol. It was demonstrated that the precipitation using a single bath of alcohol results in highly hydrophobic membranes having a water contact angle ranging from 144° (for methanol) up to 148° for n-propanol. The morphology obtained is hi-continuous. The use of the precipitation with the aid of a dual bath, firstly in alcohol (2 s) then in water, gives membranes having a bi-continuous morphology but with a smaller contact angle (136° for n-propanol).

Q. Li et al., Polym. Adv. Technol. DOI: 10.1002/pat.1549 (2009) themselves describe three other routes for preparing PVDF membranes that are highly hydrophobic (maximum water contact angle 136.6°):
from a solution of PVDF in a TEP/DMAc mixture, a step of evaporation of 60 mm is applied in a relative humidity of 60% followed by a precipitation in water. A morphology of frisée lettuce leaf type is obtained, having a weak interconnection;
by precipitation in ethanol, the same morphology is obtained in the bulk of the membrane but a rough and dense layer is obtained at the surface;
the precipitation in a dual bath (the first composed of a greater or lesser proportion of solvent, followed by a second bath of water) makes it possible to increase the surface porosity without losing the mechanical strength. However, the morphology remains that of “frisée lettuce” with a maximum water contact angle of 136.6°.

The objective of the present invention is to prepare superhydrophobic PVDF membranes. These membranes are porous and have a hierarchized surface morphology. The porosity of the membrane, combined with a two-fold level of organization, on the micrometric scale and on the nanometric scale, is capable of trapping air and makes it possible to generate superhydrophobic surface properties also known under the name of the lotus effect. This is an approach inspired by structures encountered in nature (biomimetism) on lotus leaves and the feet of water measurers (Hydrometra stagnorum). By using the VIPS process described above, it has not been possible to prepare PVDF membranes that are mechanically stable and suitable for industrial applications. Specifically, in this case, the crystalline nodules are not interconnected. It is therefore desirable to prepare PVDF membranes having a hierarchical structure of crystalline nodules, the surface of which has a porous structure on the nanometric scale (100 to 600 nm) and the nodules of which are interconnected (structure also referred to as “nanostructured morphology”).

For this purpose, and according to a first aspect, one subject of the invention is a PVDF membrane comprising a superhydrophobic surface comprising a porous structure on the nanometric scale and interconnected crystalline nodules of micrometric size. Characteristically, said superhydrophobic surface has a water contact angle of greater than or equal to 150°. The contact angle is measured by depositing an 8 μL drop of water under ambient temperature (21±3° C.) and pressure conditions. The value indicated is an average of at least 4 independent measurements.

According to a second aspect, the invention relates to a process for preparing the superhydrophobic PVDF membrane according to the invention, comprising a precipitation operation from an alcohol-water dual bath system.

The invention and the advantages that it provides will be better understood in light of the detailed description which follows and the appended figures in which:

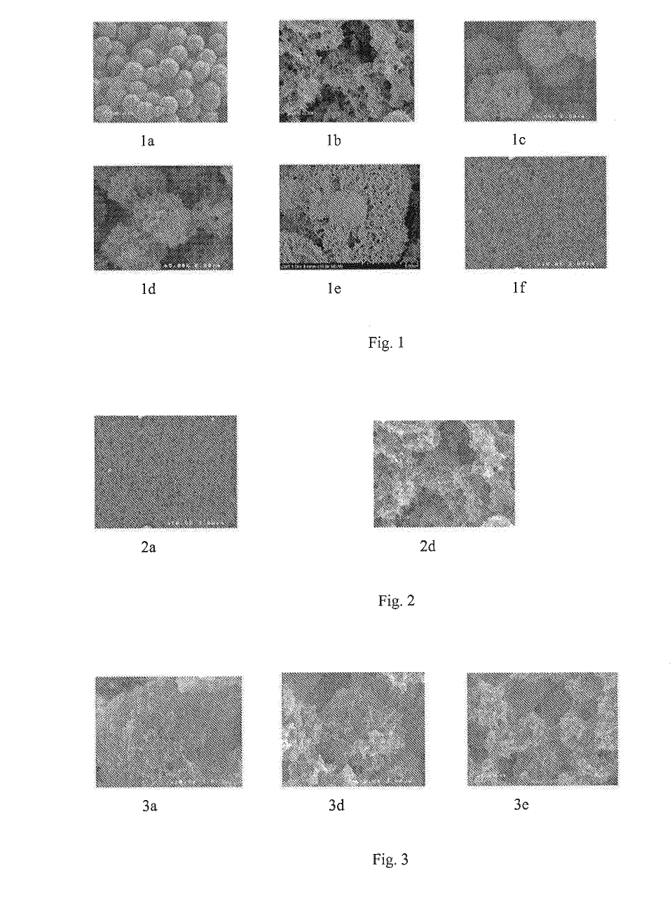

FIG. 1 illustrates the membranes prepared in example 1;

FIG. 2 illustrates the membranes prepared in example 2;

FIG. 3 illustrates the membranes prepared in example 3;

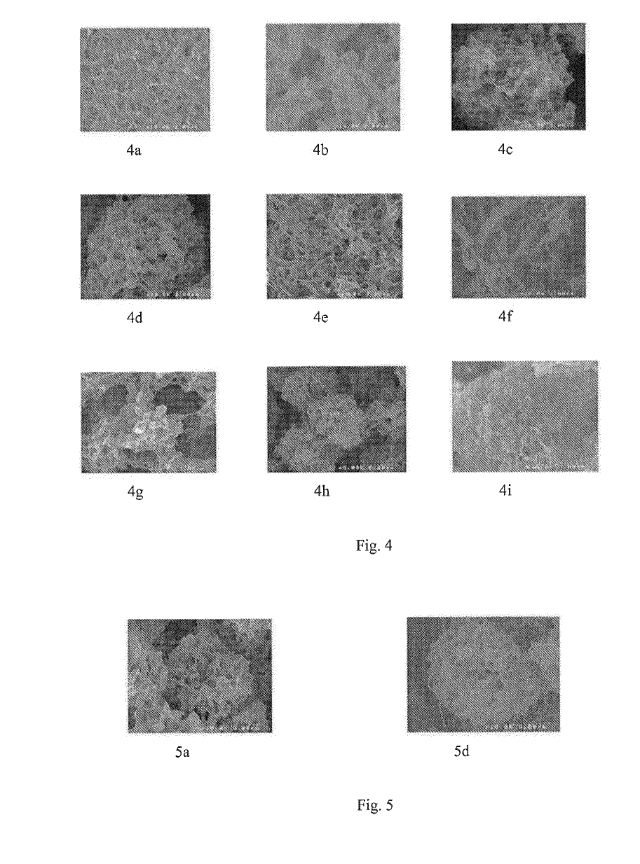

FIG. 4 illustrates the membranes prepared in example 4;

FIG. 5 illustrates the membranes prepared in example 5;

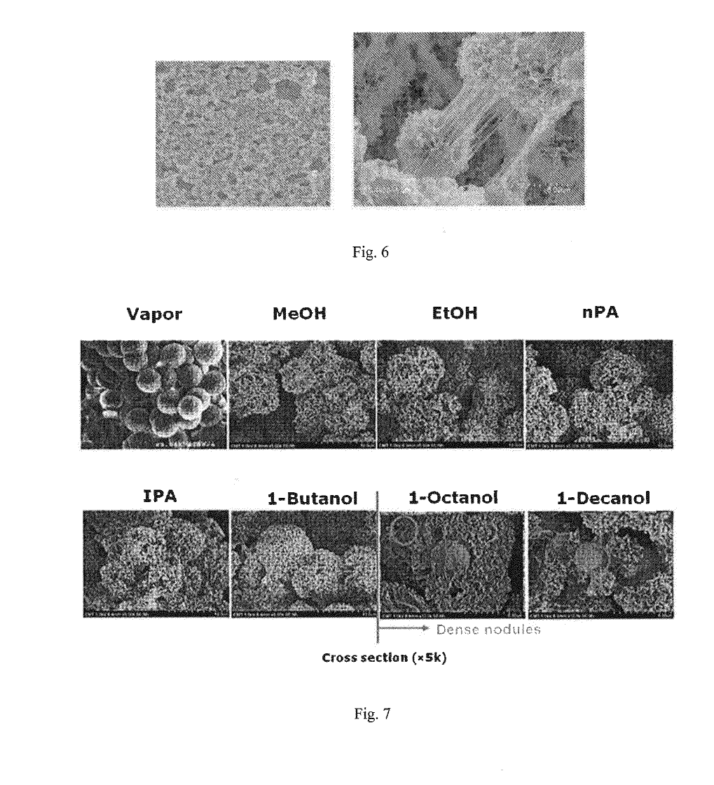

FIG. 6 is the image obtained by scanning electron microscopy (SEM) of a superhydrophobic membrane according to the invention obtained by precipitation of the PVDF in an isopropanol-water dual bath;

FIG. 7 illustrates the structure of several membranes observed using SEM, prepared by the VIPS process and by precipitation of PVDF in a dual bath of: methanol-water; ethanol-water; n-propanol-water; isopropanol-water; 1-butanol-water; 1-octanol-water and 1-decanol-water, respectively.

Hydrophobic PVDF membranes are employed on a grand scale owing to their multiple qualities: hydrophobicity, heat resistance, chemical resistance, resistance to UV radiation, etc. PVDF is a semicrystalline polymer containing a crystalline phase arid an amorphous phase. The crystalline phase confers good heat stability, whereas the amorphous phase confers flexibility on the membranes manufactured from this polymer. It is desirable to have PVDF membranes for which certain properties have been further improved. One route developed over recent years aims to increase the hydrophobicity properties of PVDF membranes, while retaining good mechanical properties, which would make them even more suitable for certain industrial applications, such as membrane distillation, filtration and Li-ion batteries, etc.

The techniques used previously for preparing PVDF membranes having high hydrophobicity are based on the phase separation induced, for example, by electrospinning, by vapor or by coagulation. The latter method consists in separating the phases by addition of a non-solvent to a PVDF solution. The known processes described above make it possible to manufacture highly hydrophobic PVDF membranes, which do not however attain the qualification of superhydrophobicity, defined as being a superhydrophobic surface having a water contact angle of greater than or equal to 150° C.

The present invention therefore proposes to provide superhydrophobic PVDF membranes, and also a process for manufacturing these membranes.

The PVDF membranes according to the invention comprise a superhydrophobic surface comprising a hierarchized structure having two levels of organization, namely an inter-nodule porosity on the micrometric scale and an intra-nodular porosity on the manometric scale, and interconnected crystalline nodules. Said superhydrophobic surface has a water contact angle of greater than or equal to 150° C. The scanning electron microscopy images show that said nodules have a size between 5 and 12 microns, preferably between 6 and 8 microns. These nodules have an inter-nodular porosity of less than 5 microns, whereas the intra-nodular pores have a submicron size (of a few hundreds of nanometers), which gives a morphology that resembles a sponge. The images also show that the nodules are connected together, which gives mechanical strength to the whole assembly. Furthermore, the PVDF membranes according to the invention have a pore volume of greater than 70%, preferably greater than 75% and advantageously greater than or equal to 80%.

The structure of the PVDF membranes according to the invention is of interconnected type. This type of structure is obtained when the phase separation takes place by spinodal decomposition, unlike phase separation by nucleation and growth which results in a dispersed phase in the form of spheric nodules. The notion of “phase” may be defined as being a portion of “uniform” material which has stable and reproducible properties. In other words, the properties of a phase are exclusively a function of thermodynamic variables and are independent of time.

The superhydrophobic PVDF membrane according to the invention is characterized by the presence of a hierarchical structure that is:
micrometric (the crystalline nodules), and
nanometric (the porous morphology of the sponge-like nodules),
   which is the origin of the superhydrophobic property. This type of structure makes it possible to trap air and prevents close contact of water with the surface which leads to very high contact angles.

Advantageously, the membrane has a resistance to a pressure ranging up to at least 5 bar, demonstrating its good mechanical strength. The reinforced (in particular textile-reinforced) membrane is subjected to pressurized water and it is verified that it remains intact.

According to a second aspect, the invention relates to a process for preparing the superhydrophobic PVDF membrane according to the invention, comprising a precipitation operation from an alcohol-water dual bath system.

The process according to the invention comprises the following steps:
a) dissolving an amount of PVDF in a solvent at a temperature of at least 60° C., said solvent being used in the pure state or with the addition of water at between 3% and 5% by weight with respect to the weight of the solvent;
b) spreading the PVDF solution thus obtained onto a solid support in order to form a film on the surface of said support;
c) immersing said film in a first bath containing an alcohol chosen from methanol, ethanol, n-propanol, isopropanol and n-butanol, for a duration of greater than or equal to 1 minute, preferably greater than or equal to 5 minutes; then
d) immersing said support in a second bath of water.

Firstly, the PVDF is dissolved in a solvent, chosen for example from the list: HMPA, DMAc, NMP, DMF, DMSO, TMP, TMU. The homogeneous solution obtained is deposited on a glass plate then spread using a blade. The glass plate is then immersed in a first coagulant bath containing either a low molecular weight alcohol such as methanol, ethanol, n-propanol or isopropanol, or a higher molecular weight alcohol such as n-butanol, n-octanol or n-decanol. Said plate is then immersed in a second bath of water, and then it is dried.

Membranes comprising a superhydrophobic surface, comprising a rough structure on the nanometric scale, and interconnected crystalline nodules have been obtained when the alcohol was methanol, ethanol, n-propanol, isopropanol or n-butanol. The nodules are interconnected and have a “sponge” morphology as shown in appended FIG. 6, which illustrates the precipitation of PVDF when the non-solvent is isopropanol.

The membranes obtained after a first bath in 1-octanol or 1-decanol have dense nodules. The denser the nodules, the less they may trap air and the lower therefore the hydrophobicity of the surface will be.

The formation of these morphologies is explained by a control of the composition paths in the ternary diagram which makes it possible to act on a mixture of S-L (crystallization) and L-L (precipitation) mechanisms.

The pore size, the porosity and the morphology of the nodules from porous nodules up to dense nodules in a bi-continuous structure including “sponge” nodules of all shapes may be obtained by acting on the polymer concentration, the temperature and the alcohol in question (FIG. 7).

The competition between the separation of the L-L phase and the crystallization was analyzed during the separation procedure using FTIR microscopy (Fourier transform infrared spectroscopy). This method made it possible to show that the surface of the PVDF membrane may vary from a hi-continuous morphology to a morphology of sponge-like nodules in order to arrive at dense nodules by acting on the coagulants with different solvent powers toward the PVDF. The use of low molecular weight alcohols, such as methanol and isopropanol, results in membranes that have a bi-continuous structure and sponge-like nodules, respectively, whereas the coagulation using higher molecular weight alcohols, such as n-octanol, results in mixed structures containing dense nodules.

The use of FTIR microscopy made it possible to study the crystallization procedure in the course of the coagulation reaction. When low molecular weight alcohols are used as non-solvents, the L-L (precipitation) mechanism dominates that of crystallization. Crystallization continues to take place sequentially, but only the rich polymer phase can form nodules. As the crystallization took place during L-L demixing, the membrane is formed of nodules with a very porous surface (sponge-type nodules),

When high molecular weight alcohols are used as non-solvents, the L-L separation curve was shifted toward the non-solvent. Crystallization prevailed over L-L demixing. Consequently, the polymer chain may form dense nodules when the crystallization takes place before the L-L separation phase.

The invention also relates to the application of the membranes described here for the distillation of water, filtration and Li-ion batteries.

The invention will now be described with the aid of the following examples, given by way of illustration and non-limitingly.

### EXAMPLE1

A homogeneous solution of PVDF at 20% by weight is prepared by dissolving the latter in NMP or DMAc at 60° C. The solution obtained is deposited on a glass plate then spread using a blade, the gap of which is fixed at 250 μm. The glass plate is then either subjected to moist air (VIPS process) in order to generate the phase separation (comparative example 1a), or immersed in a first coagulant bath containing a low molecular weight alcohol such as methanol (example 1b), ethanol, n-propanol, isopropanol (example 1c), 1-octanol (comparative example 1e) and water (comparative example 1f) for 10 min at 25° C. Said plate is then immersed in a second bath consisting of water (except in the case of the VIPS where it is immersed either in water or in ethanol), and then it is dried at ambient temperature.

The membranes thus obtained were observed using a scanning electron microscope. Their resistance to a pressure of 5 bar was furthermore measured, when the membranes are reinforced, in particular over a textile. Finally, the water contact angle is measured by depositing an 8 μL drop of water under ambient temperature (21±3° C.) and pressure conditions. The value indicated is an average of at least 4 independent measurements. Table 1 assembles the characteristics of the membranes formed. The images corresponding to these membrane samples, obtained by scanning electron microscopy, are shown in FIG. 1.

TABLE 1

| | | | | | Water |
|---|---|---|---|---|---|
| | Coagulation | | | Membrane | contact |
| | process | Second | Morphology of | resistant | angle |
| No. | (solvent) | step | the membrane | to 5 bar | (°) |
| 1a | Water | Ethanol | Isolated nodules | no | 144 ± 1 |
| | vapor | or water | formed by the | | |
| | (NMP) | | agglomeration of | | |
| | | | small dense spheres | | |
| 1b | Methanol | Water | Connected nodules | yes | 152 ± 2 |
| | (NMP) | | with a porous | | |
| | | | structure | | |
| 1c | Iso- | Water | Connected nodules | yes | 151 ± 1 |
| | propanol | | with a porous | | |
| | (DMAc) | | structure | | |
| 1d | Iso- | Water | Connected nodules | yes | 148 ± 1 |
| | propanol | | with a porous | | |
| | (NMP) | | structure | | |
| 1e | n-Octanol | Water | Dense nodules | yes/no | 132 ± 4 |
| | (NMP) | | inserted among | | |
| | | | porous nodules | | |
| 1f | Water | — | Bi-continuous | yes | 70 ± 4 |
| | (NMP) | | | | |

The presence of dense spheres is obtained when the crystallization prevails over liquid-liquid demixing (case of the VIPS process, ex. 1a). Nodules with a porous structure are obtained when the liquid-liquid demixing begins before the crystallization (case of the coagulation in light alcohols, ex, 1b, 1c and 1d). The use of heavier alcohols such as butanol gives intermediate structures with dense nodules inserted in porous nodules (ex. 1e). The bi-continuous structure, usually encountered in the case of commercial PVDF membranes, is obtained when the coagulation is carried out with a single bath of water (ex. 1f).

These results show that the use of light alcohols as the first coagulation bath makes it possible to obtain membranes having a superhydrophobic surface, for which the structure of interconnected porous nodules guarantees a mechanical resistance of 5 bar sufficient for allowing filtration applications. The presence of dense nodules, even in a small amount, weakens the structure of the membrane.

### EXAMPLE 2

### Influence of Coagulation Time in the First Bath

A homogeneous solution of PVDF at 20% by weight is prepared by dissolving the latter in NMP at 60° C. The solution obtained is deposited on a glass plate and then spread using a blade, the gap of which is fixed at 250 μm. The glass plate is then immersed in a first coagulant bath containing methanol for variable times at 25° C. Said plate is then immersed in a second bath consisting of water, and then it is dried at ambient temperature. Table 2 shows the water contact angles of the membranes formed.

TABLE 2

| First coagula- | | Coagulation | Contact | |
|---|---|---|---|---|
| tion bath | No. | time (s) | angle (°) | Morphology |
| Methanol | 2a | 0 | 70 ± 4 | Bi-continuous |
| | 2b | 5 | 132 ± 3 | — |
| | 2c | 15 | 149 ± 1 | — |
| | 2d | 60 | 153 ± 1 | Connected nodules |
| | | | | with a porous |
| | | | | structure |
| | 2e | 200 | 151 ± 1 | Connected nodules |
| | | | | with a porous |
| | | | | structure |
| | 2f | 600 | 152 ± 1 | Connected nodules |
| | | | | with a porous |
| | | | | structure |

These results show that the increase in the coagulation time in a bath of alcohol makes it possible to slow down the liquid-liquid demixing mechanism and to move from a bi-continuous morphology to a morphology of connected porous nodules. This change in morphology is accompanied by an increase in the water contact angle which becomes superhydrophobic in the case of methanol starting from an immersion time of between 15 and 60 s (ex. 2a-2d). The images corresponding to these membrane samples, obtained by scanning electron microscopy, are shown in FIG. 2.

### EXAMPLE 3

### Influence of the Percentage of Water in the Casting Solution

A homogeneous solution of PVDF at 20% by weight is prepared by dissolving the latter at 80° C. in NMP wetted with variable amounts of water (up to 6% by weight). The solution obtained is deposited on a glass plate and then spread using a blade, the gap of which is fixed at 250 μm. The glass plate is then immersed in a first coagulant bath containing a low molecular weight alcohol such as isopropanol for 10 minutes at 25° C. Said plate is then immersed in a second bath consisting of water, and then it is dried at ambient temperature.

Table 3 shows the water contact angles of the membranes formed. The images corresponding to these membrane samples, obtained by scanning electron microscopy, are shown in FIG. 3. These results show that the addition of a few percent of water to the polymer solution makes it possible to adjust the contact angle of the membranes prepared according to example 3 without modifying the porous nodule morphology obtained. It can be seen in table 3 that superhydrophobic membranes are obtained for values of additions of water to the casting solution of between 3% and 5% (ex. 3c, 3d and 3e).

TABLE 3

| First coagula- | | Water | Contact |
|---|---|---|---|
| tion bath | No. | (%) | angle (°) |
| Isopropanol | 3a | 0 | 146 ± 1 |
| | 3b | 2 | 144 ± 3 |
| | 3c | 3 | 150 ± 1 |
| | 3d | 4 | 153 ± 2 |
| | 3e | 5 | 151 ± 1 |
| | 3f | 6 | 145 ± 2 |

### EXAMPLE 4

### Influence of the Temperature of Dissolution

A homogeneous solution of PVDF at 20% by weight is prepared by dissolving the latter in NMP at temperatures between 32° C. and 110° C. The solution obtained is deposited on a glass plate and then spread using a blade, the gap of which is fixed at 250 μm. The glass plate is then immersed in a first coagulant bath containing a low molecular weight alcohol such as methanol, ethanol or isopropanol for 10 min at 25° C. Said plate is then immersed in a second bath consisting of water, and then it is dried at ambient temperature. Table 4 shows the water contact angles of the membranes formed. The images corresponding to these membrane samples, obtained by scanning electron microscopy, are shown in FIG. 4.

TABLE 4

| First coagula- | | Temperature of | |
|---|---|---|---|
| tion bath | No. | dissolution (° C.) | Morphology |
| Ethanol | 4a | 32 | Bi-continuous |
| | 4b | 45 | Bi-continuous |
| | 4c | 60 | Connected nodules with |
| | | | a porous structure |
| | 4d | 110 | Connected nodules with |
| | | | a porous structure |
| Isopropanol | 4e | 32 | Bi-continuous |
| | 4f | 40 | Bi-continuous |
| | 4g | 50 | intermediate |
| | 4h | 60 | Connected nodules with |
| | | | a porous structure |
| | 4i | 80 | Connected nodules with |
| | | | a porous structure |

The results from Table 4 show that the temperature of dissolution of the PVDF influences the morphology of the membrane obtained. Thus, bi-continuous morphologies are obtained below 50° C. whether in ethanol or isopropanol. A temperature above this value is necessary in order to obtain the morphology of connected nodules having a porous structure that is essential for obtaining superhydrophobic membranes as was seen in the preceding examples.

### EXAMPLE 5

### Influence of the Polymer Concentration on the Pore Size

A homogeneous solution of PVDF at various concentrations is prepared by dissolving the latter in NMP or in DMAc wetted with 4% of water at temperatures between 60° C. and 120° C. The solution obtained is deposited on a glass plate and then spread using a blade, the gap of which is fixed at 250 μm. The glass plate is then immersed in a first coagulant bath containing a low molecular weight alcohol such as isopropanol for 10 minutes. Said plate is then immersed in a second bath consisting of water, and then it is dried at ambient temperature.

Table 5 shows the water contact angles of the membranes prepared according to example 5. The images corresponding to these membrane samples, obtained by scanning electron microscopy, are shown in FIG. 5.

TABLE 5

| | | | | | Size of |
|---|---|---|---|---|---|
| | | Solvent | | Contact | the largest |
| First coagula- | | (T of disso- | PVDF | angle | internodular |
| tion bath | No. | lution ° C.) | (%) | (°) | pores (μm) |
| Isopropanol | 5a | NMP (60) | 20 | 152 ± 1 | 4.0 |
| | 5b | NMP (80) | 20 | 153 ± 2 | 2.6 |
| | 5c | DMAc (120) | 30 | 151 ± 1 | 1.5 |
| | 5d | DMAc (120) | 35 | 151 ± 2 | 0.25 |

The results assembled in Table 5 show that superhydrophobic membranes having the morphology of connected porous nodules may be prepared by the method proposed in the present invention using various solvents, various compositions and various temperatures. These parameters make it possible to adjust the size of the largest inter-nodular pores (determined by the minimum intrusion pressure of water into the membrane) in a range extending from 4 to 0,25 microns.

### ABBREVIATIONS

PVDF—polyvinylidene fluoride
DMF—dimethylformamide
NMP—N-methylpyrrolidone
TEP—triethyl phosphate
DMAc—N,N-dimethylacetamide
HMPA—hexamethylphosphoramide
DMSO—dimethyl sulfoxide
TMP—trimethyl phosphate
TMU—1,1,3,3-tetramethylurea

1. A polyvinylidene fluoride (PVDF) membrane comprising a surface having a water contact angle of greater than or equal to 150°.

2. The membrane as claimed in claim 1, wherein said surface comprises interconnected crystalline nodules having a size of between 5 and 12 microns.

3. The membrane as claimed in claim 2, wherein said nodules have a porous structure with an intra-nodular pore size of less than 1 μm.

4. The membrane as claimed in claim 3, wherein the nodules have an inter-nodular pore size of :less than 5 microns.

5. The membrane as claimed in claim 1, having a pore volume of greater than 70%.

6. The membrane as claimed in claim 1, characterized in that it has a resistance to a pressure ranging up to at least 5 bar.

7. A process for manufacturing the PVDF membrane as claimed in claim 1, said process comprising the following steps:
a. dissolving an amount of PVDF in a solvent at a temperature of at least 60° C., said solvent being used in the pure state or with the addition of water at between 3% and 5% by weight with respect to the weight of the solvent;
b. spreading the PVDF solution thus obtained onto a solid support in order to form a film on the surface of said support;
c. immersing said film in a first bath containing an alcohol chosen from methanol, ethanol, n-propanol, isopropanol and n-butanol, for a duration of greater than or equal to 1 minute, preferably greater than or equal to 5 minutes; then
d. immersing said support in a second bath of water.

8. The process as claimed in claim 7, wherein said alcohol is isopropanol.

9. The process as claimed in claim 7, wherein said alcohol is methanol.

10. The process as claimed in claim 7, wherein said solvent is chosen from the list: hexamethylphosphoramide (HMPA), N,N-dimethylacetamide (DMAc), N-methylpyrrolidone (NMP), dimethylformamide (DMF), dimethyl sulfoxide (DMSO) trimethyl phosphate (TMP), 1,1,3,3-tetramethylurea (TMU).

11. The process as claimed in claim 7, wherein the PVDF membrane is prepared by drying said support at ambient temperature.

12. An industrial application comprising the use of the membrane as claimed in claim 1.

13. The industrial application of claim 12, wherein said industrial application comprises the use of said membrane as a filtration membrane.

14. The industrial application of claim 12, wherein said industrial applications comprises the use of said membrane in a lithium battery.

15. The membrane as claimed in claim 2, wherein said surface comprises interconnected crystalline nodules having a size of between 6 and 8 microns.

16. The membrane as claimed in claim 5, baying a pore volume of greater than 75%.

17. The membrane as claimed in claim 1, having a pore volume of greater than 80%.

18. The industrial application of claim 12, wherein said industrial application comprises the use of said membrane in a lithium battery.
